(19) United States
(12) Patent Application Publication
(10) Pub. No.: US 2025/0078380 A1
(43) Pub. Date: Mar. 6, 2025

(54) Script-Based Animations for Live Video

(71) Applicant: Adobe Inc., San Jose, CA (US)

(72) Inventors: Yining CAO, La Jolla, CA (US); Stefano PETRANGELI, Mountain View, CA (US); Li-Yi WEI, Redwood, CA (US); Rubaiat HABIB, Seattle, WA (US); Deepali ANEJA, Seattle, WA (US); Balaji Vasan SRINIVASAN, Bangalore (IN); Haijun XIA, San Diego, CA (US)

(21) Appl. No.: 18/241,155

(22) Filed: Aug. 31, 2023

(51) Int. Cl. G06T 13/80; G06F 40/56; G06V 40/20; H04N 21/2187; H04N 21/431

(52) U.S. Cl. CPC G06T 13/80; G06F 40/56; G06V 40/20; H04N 21/2187; H04N 21/4312

(57) ABSTRACT

In various examples, a video effect is displayed in a live video stream in response to determining a portion of an audio stream of the live video stream corresponds to a text segment of a script associated with the video effect and detecting performance of a gesture. For example, during presentation of the script, the audio stream is obtained to determine if a portion of the audio stream corresponds to the text segment. In response to the portion of the audio stream corresponding to the text segment, detecting performance of a gestures and causing the video effect to be displayed.

### BACKGROUND

Recent years have seen a proliferation in the use of video, which has applications in practically every industry, from film and television to advertising and social media. Businesses and individuals routinely create and share video content in various contexts, such as presentations, tutorials, commentary, news and sports segments, blogs, product reviews, testimonials, comedy, dance, music, movies, and video games, to name a few examples. Video can be captured using a camera, generated using animation or rendering tools, edited with various types of video editing software, and shared through multiple outlets. Indeed, recent advancements in digital cameras, smartphones, social media, and other technologies have provided many new ways that make it easier for even novices to capture and share a video. With these new ways to capture and share video comes an increasing demand for video editing features during live performances.

### SUMMARY

Embodiments described herein are directed to providing gesture based animations and other video effects during live video performances. In various examples, users are provided with a script authoring interface that allows a user to generate a script and apply video effects to text segments of the script that are displayed during a presentation in response to gestures that are performed. In particular, in such examples, the user selects portions of the script (e.g., words, sentences, paragraphs, etc.) and selects a state of an object (e.g., scale, position, rotation, etc.) in a preview video to be applied to a live video performance (e.g., during presentation) as a result of a gesture being performed. A presentation interface allows the user, in such examples, to perform the script and generates a video of the user's performance, including the video effect when the user performs the gestures and/or speaks the text segment from the script. In one example, when the user says a text segment in the script associated with an animation of an object, an adaptation interval is started based on the user's performance of the gesture, and the object is then animated based on the graphical parameters assigned by the user during script authoring.

In various examples, in order to adapt animations to the user's gestures in real-time (e.g., during live performances), the script authoring interface allows the user to generate a mapping between graphical states of objects during the animation to gestures performed by the user. In a specific example, using a video preview of the script authoring interface, the user selects the scale, location, and angle of an object for a first frame of an animation relative to a gesture. This process can be repeated for a plurality of frames to define the animation of the object in various examples. Furthermore, in these examples, the user selects a text segment of the script to associate with a particular animation.

Turning to presentation of the script, in an example, a script location prediction model obtains the script and a transcript of an audio stream of the user presentation and generates a sequence of probabilistic locations within the script based on the transcript of the audio stream. In this example, once the user's current location within the script reaches a text segment associated with an animation, a gesture model determines a similarity between the user's current gesture (e.g., the user's hand position and/or pose in the live video) and the stored gesture parameters generated during script authoring. Continuing this example, if the current gesture matches (e.g., is sufficiently similar) to the stored gesture parameters, then the animation is started. Once the animation is started, in various examples, weight values are used to advance or otherwise adapt the animation based on the user's speech and/or the user's gestures. This allows the application to handle deviations in the performance of the script and/or gestures by the user during presentation.

### BRIEF DESCRIPTION OF THE DRAWINGS

The present invention is described in detail below with reference to the attached drawing figures, wherein:

FIG. 1 depicts an environment in which one or more embodiments of the present disclosure can be practiced.

FIG. 2 depicts a user interface of an application including a script authoring interface which is provided to a user, in accordance with at least one embodiment.

FIG. 3 depicts a user interface of an application including a script authoring interface which is provided to a user, in accordance with at least one embodiment.

FIG. 4 depicts a script authoring interface and a presentation interface for displaying video effects associated with gestures in a video of a presentation, in accordance with at least one embodiment.

FIGS. 5A-5C depict a user interface of an application including a presentation interface which is provided to a user, in accordance with at least one embodiment.

FIG. 6 depicts an example process flow for authoring a script including triggers for video effects during presentations, in accordance with at least one embodiment.

FIG. 7 depicts an example process flow for displaying video effects in a video during presentation of a script, in accordance with at least one embodiment.

FIG. 8 is block diagram of an example computing system for script authoring and presentation, in accordance with embodiments of the present disclosure.

FIG. 9 is a block diagram of an exemplary computing environment suitable for use in implementations of the present disclosure.

### DETAILED DESCRIPTION

Embodiments described herein generally relate to providing gesture guided video effects and or animations for live video performances. In accordance with some aspects, the systems and methods described are directed to an application that provides users with a script authoring interface that allows a user to generate a script and apply video effects to portions of the script (e.g., text segments of the script) that are tied to gestures performed by a presenter during presentation. In particular, in one embodiment, the user selects portions of the script (e.g., words, sentences, etc.), then selects a state of graphical element and a gesture to trigger the state of the graphical element. For example, the user can select an image to appear within an area of the video when the trigger is detected (e.g., the words of the text segment are spoken and/or the gesture is performed). In such examples, a plurality of states of the graphical element and corresponding gestures can be generated during script authoring such that when the triggers (e.g., the gestures) are detected, the graphical element is animated within a video stream capturing the presentation (e.g., live video stream).

In various embodiments, a presentation interface provided by the application allows the user to perform the script and generates a video stream of the user's performance, including video effects corresponding to the portions of the script selected by the user (e.g., the set of text segments). As in the example above, the triggers are generated based on gestures (e.g., a vector representation of a hand displayed in an image and/or video) and associated with particular states of the graphical element (e.g., a set of parameters defining attributes of the graphical element) provided by the user during script authoring and, in turn during presentation, script following is performed to track the user's progression in the script and detect the triggers. For example, an audio stream capturing the user's presentation is transcribed, and a location within the script is determined. In such examples, when a text segment associated with the video effect is detected, an adaptation interval is initiated and the application or component thereof (e.g., gesture model) monitors the user to detect the gesture to trigger the video effect. Furthermore, during the adaptation interval, in various embodiments, the video effect is advanced (e.g., to the next state of the graphical element) based on weight values applied to the location of the user within the script and gestures performed by the user.

In an embodiment, during the adaptation interval, graphical parameters of the video effects (e.g., states of the graphical element defined by the user and/or intermediate states between those defined by the user) are determined based on a speech interval associated with the text segment and a gesture of the user at the current time. In one example, the speech interval is determined based on an amount of time the user takes to speak the text segment and the video effect between the start of the user speaking (e.g., when the user speaks the first word of the test segment during presentation) and the end of the user speaking the text segment (e.g., based on an average amount of time users take to speak the words of the text segment). In an embodiment, a similarity between a current gesture being performed by the user and a recorded gesture (e.g., the gesture performed by the user during script authoring) is also used to determine the video effect state to be displayed in the live video stream.

During presentation of the script, in an embodiment, once a particular text segment corresponding to a particular video effect is detected and the adaptation interval has been initiated, dynamic weight values are applied to the user's gesture and speech to determine how the video effect is adapted and/or advanced. For example, a larger weight value causes the video effect to be controlled by the user's gestures (e.g., advanced to the next state of the animation in response to a gesture performed by the user). In another example, a smaller weight value causes the video effect to be controlled or otherwise advanced base on the user's speech (e.g., the user's location in the script).

In various embodiments, during script authoring and presentation, a gesture model generates or otherwise captures a user's gesture (e.g., a vector representing attributes of the user's hand positioning and/or pose). For example, during script authoring the user selects a state of an animation (e.g., location, scale, and positioning of graphical elements) for a frame of the animation and causes the application to record or otherwise store a corresponding gesture (e.g., storing the vector representation of the gesture). Continuing this example, during presentation, the user's gestures are monitored periodically or aperiodically, and a similarity between the user's current gesture and stored gestures is calculated to determine an intentionality of the user's current gesture (e.g., whether the user is intentionally performing a gesture intended to trigger an animation).

In various embodiments, if the user is static for an interval of time, the video effect can be triggered and/or advanced during the adaptation interval. For example, if the total movement of the user's hand over an interval of time (e.g., one second) is less than a threshold, intentionality of the user's current gesture is determined and the video effect is triggered and/or advanced. In an embodiment, a discrepancy penalty is added to the weight value as a result of the user's gestures deviating from the user's speech. For example, the user forgets to read a portion of the script or forgets to perform a certain gesture. In such examples, the discrepancy penalty allows for faster convergence to a state of the video effect defined by the user.

Aspects of the technology described herein provide a number of improvements over existing technologies. For instance, traditional video editing tools are expensive and complex, requiring that the user be trained to use generally complex user interfaces. To become adept, users of video editing must acquire an expert level of knowledge and training to master the processes and user interfaces for typical video editing systems. Additionally, video editing tools for live performances often fail to provide the desired results due to the unpredictability or deviations of a presenter's actions and the difficulties in preparing animations aligned with intended speech and gestures. These deviations lead to increased preparation costs and cognitive load during the performance, as well as reduced visual quality compared to edited recorded content. Furthermore, traditional video editing tools can be inherently slow and fine-grained, resulting in editing workflows that are often considered tedious, challenging, or even beyond the skill level of many users. In other words, video editing that requires selecting video frames or time ranges provides an interaction modality with limited flexibility, limiting the efficiency with which users interact with conventional video editing interfaces. Embodiments of the present disclosure overcome the above, and other problems, by providing mechanisms for coordinating animations and gestures during presentation of live video without the need for traditional frame by frame video editing.

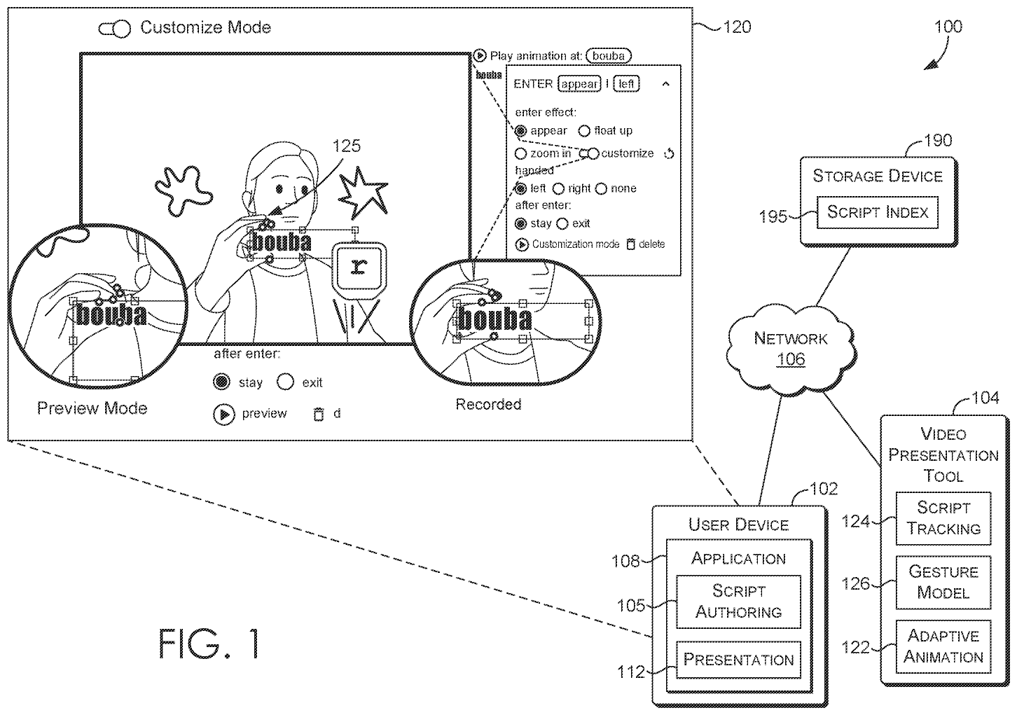

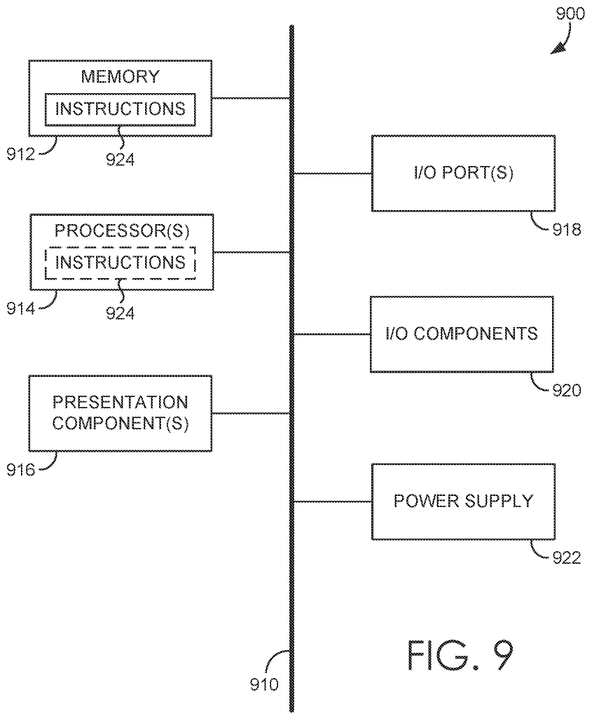

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, video presentation tool 104, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the video presentation tool 104 includes multiple server computer systems cooperating in a distributed environment to perform the operations described in the present disclosure.

User device 102 can be any type of computing device capable of being operated by an entity (e.g., individual or organization) and obtains data from knowledge distillation tool 104 and/or a data store which can be facilitated by the video presentation tool 104 (e.g., a server operating as a frontend for the data store). The user device 102, in various embodiments, has access to or otherwise maintains a storage device 190 which stores a script index 195 and/or video effects to be applied to a video during a presentation (e.g., live performance of a script by a user using the user device 102). For example, the application 108 includes a video editing application to enable script editing, video editing, real-time previews, playback, and video presentations including video effects, such as a standalone application, a mobile application, a web application, and/or the like. Furthermore, in various embodiments, video effects include video visualizations and/or animations that can be applied or otherwise displayed in video including non-visual effects such as audio effects. In one example, the animation includes graphical elements such as images or objects that are animated or otherwise modified over a plurality of frames.

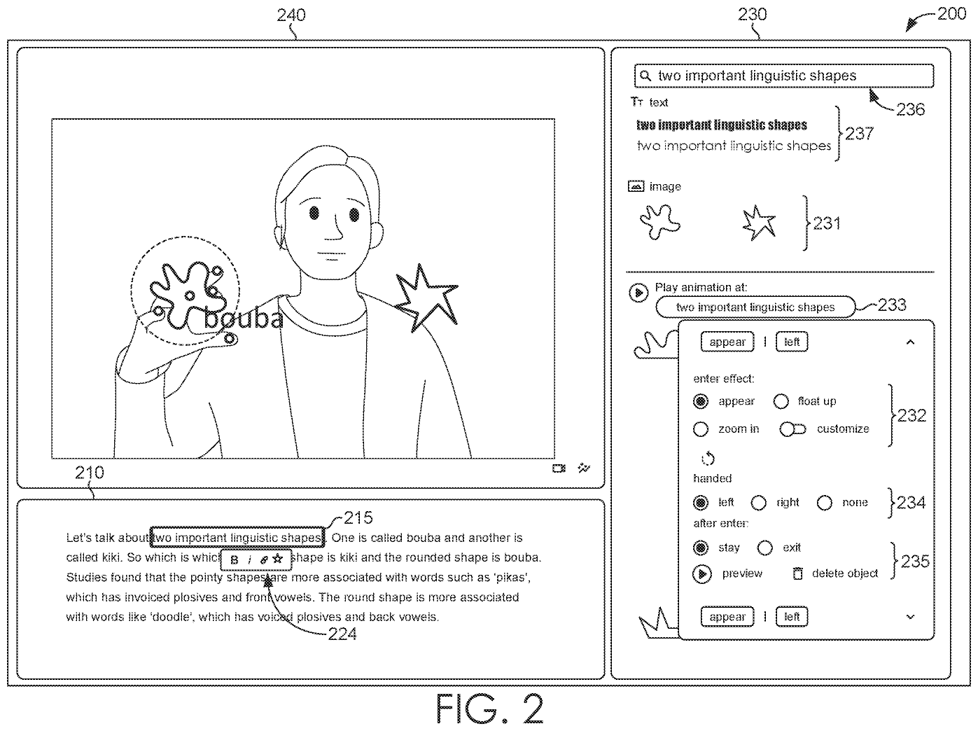

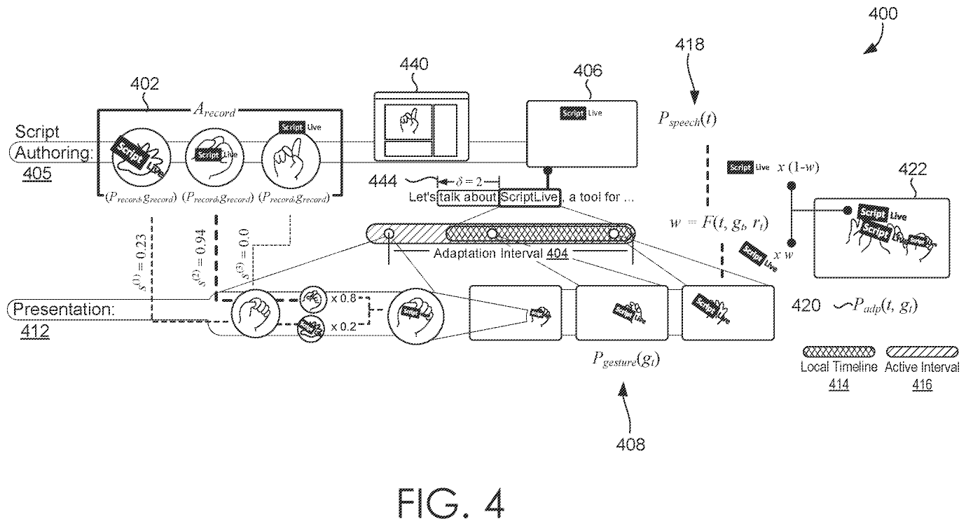

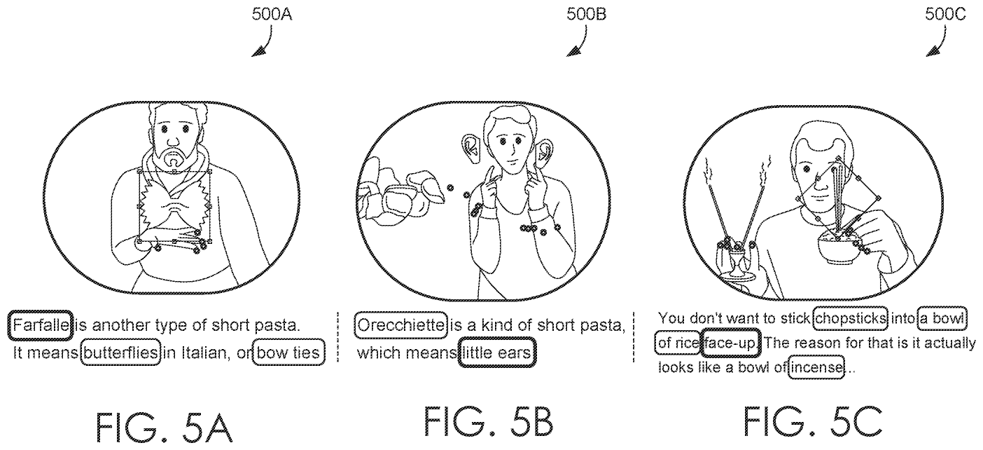

In various embodiments, to enable these operations, the application 108 includes script authoring 105 user interface or other component and a presentation 112 user interface or other component. For example, the script authoring 105 user interface enables the user to generate text for a script and select text segments to associate with video effects, as described in greater detail below in connection with FIG. 2. In another example, the presentation 112 user interface enables the user to perform or otherwise present the script in a video stream or other live performance, including the video effects as described in greater detail below in connection with FIGS. 4 and 5A-5C. Although some embodiments are described with respect to the script authoring 105 user interface and the presentation 112 user interface, some embodiments implement aspects of the present techniques in other types of applications and/or additional applications, such as those involving text-based video editing, transcript processing, visualization, animations, and/or interaction.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the video presentation tool 104. For example, the application 108 obtains a transcript of an audio stream corresponding to a video stream from a transcription service (not shown in FIG. 1 for simplicity) of the video presentation tool 104. In yet other examples, the application 108 obtains information indicating a location within the script from the video presentation tool 104. In some implementations, the application 108 comprises a web application, which can run in a web browser, and can be hosted at least partially on the server-side of the operating environment 100. In addition, or instead, the application 108 can comprise a dedicated application, such as an application being supported by the user device 102, the video presentation tool 104, and/or the storage device 190 (e.g., a remote storage device hosted by a computing resource service provider). In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

For cloud-based implementations, for example, the application 108 is utilized to interface with the functionality implemented by the video presentation tool 104. In some embodiments, the components, or portions thereof, of the video presentation tool 104 are implemented on the user device 102 or other systems or devices. Thus, it should be appreciated that the video presentation tool 104, in some embodiments, is provided via multiple devices arranged in a distributed environment that collectively provides the functionality described herein. Additionally, other components not shown can also be included within the distributed environment.

As illustrated in FIG. 1, the user device 102 provides a user with a user interface 120 to enable the user to perform script authoring 105 (e.g., via the user interface 120) and/or presentation 112 (e.g., via the user interface 120). For example, the user can generate a script through the script authoring 105 user interface and associate video effects with text segments of the script and gestures to be performed during presentation 112. In an embodiment, the video presentation tool 104 or other application (e.g., the application 108), generates a script index 195 corresponding to the script, which enables the video presentation tool to perform script tracking using a script tracker 124 during presentation 112 of the script based on a transcript (e.g., a conversion of audio to text) generated from audio of corresponding to the video of the presentation. Furthermore, in some embodiments, the script index 195 and/or video effects are stored in the storage device 190. In an example, the storage device 190 includes one or more computer readable media.

In various embodiments, the user device 102 is a desktop, laptop, or mobile device such as a tablet or smartphone, and the application 108 provides one or more user interfaces, including the user interface 120. In some embodiments, the user accesses the script through the script authoring 105 user interface of the application 108, and/or otherwise uses the application 108 to identify the location where the script is stored (whether local to the user device 102, at some remote location such as the storage device 190, or otherwise stored in a location accessible over the network 106). For example, the user, using an input device such as a keyboard, provides inputs to the application 108 to generate the text of the script. Furthermore, in such examples, the user then selects, through the user interface 120, text segments (e.g., letters, words, sentences, paragraphs, etc.) of the script and indicates video effects to be applied during the presentation 112.

In addition, in an embodiment, the user performs a gesture 125 which is recorded or otherwise captured by the user device 102 and provided to a gesture model 126 and associated with a frame and/or state of a video effect to be displayed during the presentation 112. In one example, a camera of the user device 102 captures an image of the gesture 125 and provides the image to the gesture model 126 and/or video presentation tool 104. Continuing this example, the gesture model 126 generates information defining the gesture 125 (e.g., a vector representing hand position, finger angle, hand center, angle of rotation, pose, or other attributes of the user and/or the user's hand) and generates a record of the gesture and the frame and/or state of the animation (e.g., attributes of the graphical element to be displayed such as scale, rotation, offset, etc.) for storage in the storage device 190.

Additionally, or alternatively, in various embodiments, the user accesses the presentation 112 user interface of the application 108 and records a video using video recording capabilities of the user device 102 (or some other device) and/or some application executing at least partially on the user device 102. For example, the user, through the user interface 120, initiates recording of the video and performs the script (e.g., text displayed in a teleprompter 110), audio corresponding to the video is provided to the video presentation tool 104. In this example, the video presentation tool 104 causes the transcription service to generate a transcript (e.g., by at least converting the audio to text using one or more machine learning models) and, based on the transcript, determines a location (e.g., a word and/or text segment in the script corresponding to words spoken by the user). In various embodiments, the script tracker 124 performs script tracking using various techniques. In one example, the script tracker 124 performs script tracking based on the script index 195 and a transcript and/or audio obtained by the user device 102 during presentation 112 as described in U.S. application Ser. No. 18/346,051 filed on Jun. 30, 2023, the entire contents of which are herein incorporated by reference in their entirety. In other examples, the script tracker 124 performs script tracking using other techniques such as timing, monitoring key words, queues, transcripts, or any other suitable technique to determine the user's location within the script at an interval of time (e.g., the current time).

As described in more detail below, in various embodiments, the application 108 performs video edits and/or otherwise applies video effects in response to the video presentation tool 104 or other application detecting a trigger associated with a text segment (e.g., a portion of the script for which the user applied a frame of the animation to using the script authoring interface). For example, the animations are applied to a live video stream through the selection of words, phrases, or text segments from the script and applying or otherwise associating a frame of the animation to a word in a text segment. In such an example, information indicating the word of the text segment, the frame of the animation, and the gesture 125 are stored in the storage device 190. In an embodiment, as described in greater detail below in connection with FIG. 2, the user provides a layout corresponding to a frame of the animation. For example, the layout includes a graphical element to overlay on the video and information defining the graphical element such as effect, font, size, style, animation (e.g., the graphical element can include an animated image in the Graphics Interchange Format (GIF)), or other attributes to apply during presentation. In other examples, the layout indicates position and/or orientation of visualizations (e.g., images, animations, etc.) and/or video effects with the video. In an embodiment, the application 108 applies selected video effects to a segment of the video such that when the video is displayed (e.g., streamed to another user device) at the time when the selected word, phrase, or text segment is spoken, the video effect will also appear.

In some embodiments, after presentation 112 of the video is completed and the intended video effects have been applied, the user can save or otherwise export the video generated during presentation 112 to another application such as a video editing application. In other embodiments, the application 108 produces a video of the presentation including the video effects without the need for post-processing.

In various embodiments, the application 108 generates the script index 195 based on the script generated during script authoring 105. In an embodiment, the script index 195 includes a data structure that stores the script and is used by the video presentation tool 104 to track or otherwise monitor a location within the script and cause the video effects to be applied to the video during presentation 112. In one example, the script index 195 includes a key-value store where the keys correspond to the location (e.g., the sequence of words in the script) and the values correspond to the words in the script.

In various embodiments, based on the location indicated by the script tracker 124, the application 102 or other component illustrated in FIG. 1, in various embodiments, determines whether the location is associated with a trigger for displaying a video effect. For example, the script tracker 124 obtains a transcript of the audio stream of the presentation from the transcription service and determines if the text converted from the audio stream corresponds to or otherwise matches a particular text segment associated with a particular animation. In addition, during script authoring 105, the selection of the text segment, in an embodiment, is extended or otherwise modified to include a plurality of words preceding the first word of the text segment selected by the user. For example, by extending the text segment, the video presentation tool 104 can handle situations where the gesture 125 precedes the words of the text segment spoken by the user.

In various embodiments, the transcription service identifies words in an audio file and/or audio stream. In one example, the transcription service includes one or more machine learning models that convert audio to text. In an embodiment, the transcription service includes a first machine learning model that generates text from audio based on words spoken in the audio and a second machine learning model that modifies the text based on context information obtained from previously generated text from the first machine learning model. For example, as the user speaks, the second machine learning models modifies the output of the first machine learning model based on context information determined from the output of the first machine learning model.

In various embodiments, once the script tracker 124 or other component illustrated in FIG. 1 determines the user, during presentation 112, is at a location in the script corresponding to the text segment associated with the video effect, an adaptation interval is initiated during which adaptive animation 122 is performed. In one example, once the adaptation interval is initiated (e.g., in response to the user speaking the first word of the text segment), the gesture model 126 determines whether gestures performed by the user match gestures recorded during script authoring 105. Furthermore, in this example, the video presentation tool 104 performs adaptive animation 122 to transition and/or advance the video effect to the next frame of the video effect. In various embodiments, as described in greater detail below in connection with FIG. 4, the adaptive animation 122 adjusts the video effect in real-time (e.g., as the user is presenting during presentation 112) while maintaining the association of the video effect with portions of the text segment and gestures. For example, the adaptive animation 122 enables the video presentation tool to display the video effect is indicated by the user during script authoring 105 despite changes or deviations by the user during presentation 112.

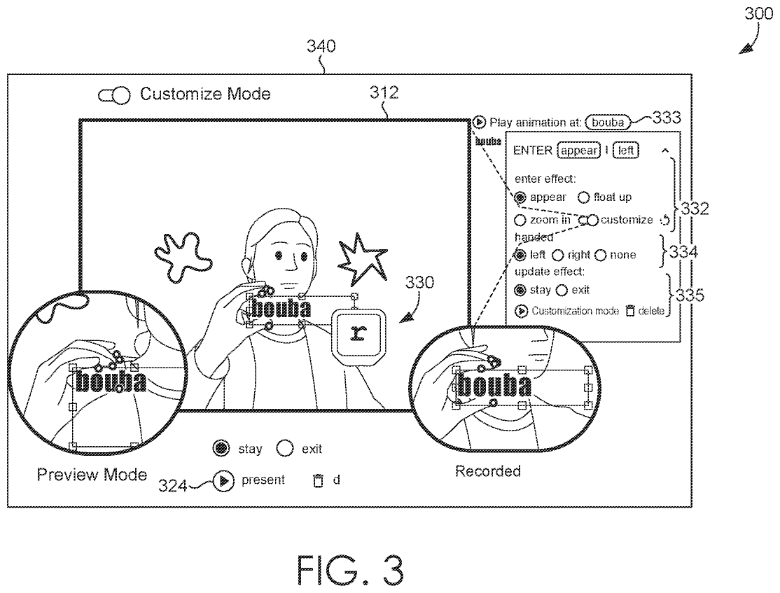

FIG. 2 depicts a user interface 200 of an application, including a script authoring interface 210 which is provided to a user, in accordance with at least one embodiment. FIGS. 2 and 3 depict user interfaces 200 and 300 that are generated by an application, such as the application 108, as described above in connection with FIG. 1. In some embodiments, the user interfaces 200 and 300 are generated at least in part by other applications. For example, a preview panel 240 of the user interface 200 includes a video preview which can be generated at least in part by a video capture application or other application that provides data to the application 108. In addition, in some embodiments, data or other information displayed in the user interfaces 200 and 300 are obtained from other applications and/or devices including remote applications, services, and devices. In one example, an animation panel 230 of the user interface 200 displays a set of objects that can be animated in a video during presentation and which are obtained from an image service of a computing resource service provider. Furthermore, in various embodiments, additional panels or graphical user interface elements are included in the user interfaces 200 and 300 to provide users with additional functionality. For example, a sound effects panel can be included in the user interface 200. Fewer or additional panels or graphical user interface elements can be included in the user interfaces 200 and 300 in various embodiments.

In various embodiments, the user interface 200 includes the script authoring interface 210, the animation panel 230, and the preview panel 240. In various embodiments, the script authoring interface 210 provides an interface for creating, editing, saving, exporting, deleting, or otherwise generating a script for presentation. In the example illustrated in FIG. 2, the script authoring interface 210 provides text generating and modification features such as word processing. In an embodiment, the script authoring interface 210 includes a graphical user interface element 224, which includes an animation button represented as a star in FIG. 2, that, as a result of being selected, allows the user to apply video effects to a text segment 215.

In various embodiments, the animation panel 230 presents various options that can be applied to the video effect, and the preview panel 240 provides a preview of the video. For example, the preview video displays a live stream of video to the user to allow the user to see the current state of the video effect and/or gestures to allow the user to determine and/or generate, using the application, a frame of the video effect and corresponding gesture. In the example illustrated in FIG. 2, the animation panel 230 includes a search bar 236, text overlay options 237, image options 231, text segment information 233, enter effect options 232, handed options 234, and after enter options 235. The search bar 236, in an embodiment, allows the user to search for images or other graphical elements related to the query in the search bar. For example, the text segment 215, once selected by the user, can be used as a search query in the search bar 236 to return relevant images that the user can use in the video effect.

In an embodiment, text overlay options 237 enable the user to select various layout and text stylization options for a text overlay to be used in the video effect. In one example, the text segment 215 selected by the user is used to generate a text overlay that is animated at least in part using gestures recorded by the user. In various embodiments, the image options 231 displays images or other graphical elements that the user can select and use in the video effect. For example, the images displayed in the image options 231 correspond to relevant images obtained from the search query provided to the search bar 236. In an embodiment, the text segment information 233 indicates the selected text segment or portion thereof. For example, the user can select a portion of the text segment 215 (e.g., the word “important”) and apply a particular frame of the video effect and/or gesture. Continuing this example, this enables the user to associate particular portions of the text segment 215 with particular frames of the video effect and/or particular gestures.

In various embodiments, the enter effect options 232 allow the user to define attributes of a graphical element (e.g., an image) in the video effect in response to the video effect being triggered. In one example, as described in greater detail below in FIG. 3, the user can define various attributes of the graphical element such as size, scale, rotation, and/or location. In an embodiment, the handed options 234 allow the user to associate particular gestures with a hand. For example, the user can define a gesture as a left-handed gesture such that the application will trigger the video effect in response to the gesture being performed by the user's left hand. In another example, the user can define “no hand” for the gestures, and the application can trigger the video effect in response to either hand performing the gesture. Furthermore, in various embodiments, the gestures include actions and/or movements performed by additional body parts with or without the use of the user's hands. For example, the gestures can include a particular facial expression or head pose. In various embodiments, the after enter options 235 allow the user to define attributes of a graphical element (e.g., an image) in the video effect during a state after the video effect has been triggered. For example, the user can cause a frame of the animation to stay within the video for an interval of time after the text segment 215 has been spoken by the user during presentation.

In various embodiments, the script authoring interface 210 presents at least a portion of the script and allows the user to highlight or otherwise select the text segment 215 and select text stylization, video effect, audio effect, animation, transition, image, overlay, or other graphical or non-graphical effect using the graphical user interface element 224. In the example illustrated in FIG. 2, the user selects the animation button of the graphical user interface element 224 and associates the text segment 215 with an animation defined by the user as described in greater detail below in connection with FIG. 3. For example, the user, through the user interface 200, defines frames of the animation and performs corresponding gestures stored by the application.

In some embodiments, upon selection of the animation button corresponding to the text segment 215, the animation panel 230 provides and displays corresponding animation options (e.g., options for modifying attributes) associated with the animation or frames thereof. Additionally, in various embodiments, the animation panel 230 provides an add frame button that provides a mechanism for adding animation frames to the animation corresponding to the text segment 215 during presentation.

FIG. 3 illustrates a user interface 300 of an application including a customize mode interface 340 which is provided to a user, in accordance with embodiments of the present disclosure. In various embodiments, the user interface 300 is a continuation of a script authoring process as described in FIG. 2. For example, once the text segment and video effect are selected by the user via the user interface 200, the user can initiate the customize mode interface 340 in order to define gestures and frames of the video effect. In an embodiment, the user interface 300 includes text segment information 333, enter effect options 332, handed options 334, update effect options 335, and a video playback region 312. In one example, text segment information 333 presents a visualization of a text segment or portion thereof selected by the user for a frame of the video effect and corresponding gesture.

In various embodiments, once the user selects a text segment or portion thereof (e.g., “bouba,” as illustrated in FIG. 3) to map or otherwise associate with a video effect, the user defines the video effect properties (e.g., the properties of the graphical elements of a particular frame of the animation) and the mapping between the video effect properties and gestures. For example, the user defines the video effect properties using text segment information 333, enter effect options 332, handed options 334, and update effect options 335. Furthermore, in various embodiments, the user continues the process by selecting more text segments to apply to video effects and define more video effect effects in the script in an interactive and iterative manner.

In an embodiment, once the user has defined the video effect properties for a particular frame of the video effect, the user clicks a “present” button 324 to start practicing and/or present the corresponding gesture. For example, once the user selects the present button, the user narrates through the script and performs the recoded gestures, and video effects occur following the user's speech and adapt to the user's gesture performed in real-time. In an embodiment, to enable mapping between speech and video effects during script authoring, the application uses the script as a global timeline. In one example, using the script as a global timeline allows users to directly specify the intended timing of video effects in relation to the script rather than relying on an approximate time period measured in seconds.

The user interface 300 includes two types of video effect properties: the enter effect options 332 and the update effect options 335. In one example, the enter effect options 332 define video effect properties that allow the user to add or otherwise include a new graphical element to the video (e.g., in response to a text segment, gesture, and/or other trigger). In addition, in an example, while the update effect options 335 define video effect properties that transform existing graphical elements (e.g., modifying at least one property of the video effect). In various embodiments, to add an “enter” animation (e.g., adding a new graphical element to an using the enter effect 332 options), the user selects a graphical element (e.g., image, text, animation, effect, etc.) in the user interface 300 and adds the graphical element to the video (e.g., by clicking on a button, dragging and dropping the graphical element, or otherwise interacting with the user interface 300). In an example, the graphical element can then be directly manipulated to specify a state of the animation (e.g., by manipulating the squares defining a bounding box around the graphical element). In various embodiments, to add an “update” animation (e.g., using the update effect options 335 to modify video effect properties), users directly manipulate the graphical element to add a state change to the video effect (e.g., generate a new frame). In one example, the user modifies an existing graphical element to initiate a procedural video effect (e.g. hand following).

In various embodiments, the video effect properties specified by the user through the enter effect options 332 and the update effect options 335 specify the video effect that plays starting and during a specified local timeline (e.g., an interval of time defined by the text segment of the script which corresponds to the video effect). In one example, the enter effect options 332 include various templates entering animations, such as a zoom-in effect or float-up effect. In another example, the update effect options 335 include various template update animations such as a transform-to effect, a hand-follow effect, a seesaw effect, and an exit effect. In various embodiments, the user interface 200 also allows users to create or otherwise generate various customized animations with gesture demonstration.

In an embodiment, the handed options 334 allow the user to specify which hand gesture the video effect will adapt to during presentation. In the example illustrated in FIG. 3, the user can choose between the “left,” “right,” and “none” options. In this example, selecting “none” causes the video effect to not be adapted to a hand when the gesture is performed. Furthermore, in an embodiment, the user specifies the behavior of the object after the video effect is played. For example, the user interface 200 provides “stay” “exit,” and “hand-following” options to allow the user to select the behavior of the graphical elements after the animation and/or a particular frame of the animation is displayed.

In one example, to access the customize mode interface 340, users can toggle on the “customize” mode using the graphical user interface element of the enter effect options 332 illustrated in FIG. 3. In an embodiment, the user demonstrates or sets the graphical elements in the desired states and performs the gesture simultaneously to record the frame of the video effect associated with the text segment or portion thereof. In the example illustrated in FIG. 3, the user performs a pinch gesture and moves the text object to be center-aligned with index and thumb fingers in video playback region 312. Once the user is satisfied with the mapping presented in video playback region 312, in this example, the user presses a record button 330 to cause the application displaying the user interface 300 to generate the mapping between the hand gesture and the state graphical element. In the example illustrated in FIG. 3, the circles at the end of the fingers illustrate the gesture and indicate that the gesture has been recorded. Furthermore, in an embodiment, the user can generate multiple mappings using the process described above, allowing the user to create a wide range of custom gestures to animate the graphical elements of the video effect. In various embodiments, the user interface 300 can allow the user to reset or clear a previously recorded gesture and/or state of the video effect. Additionally, in some embodiments, the user can select or otherwise specify fallback video effects that will be triggered if a particular gesture is not detected during presentation.

In an embodiment, once the video effect has been created by the user, the user can preview the video effect (e.g., by clicking the “preview” button and performing hand gestures). For example, the preview simulates the start of the local timeline (e.g., the text segment associated with the animation) and allows users to view how the video effect adapts to the performed gesture. Furthermore, in various embodiments, when the user is satisfied with the results previewed video effect, they can select the present button to initiate the presentation interface, which includes script tracking, as described above in connection with FIG. 1.

FIG. 4 illustrates a diagram 400 of a script authoring 405 interface and a presentation 412 interface for displaying video effects associated with gestures in a video 422, in accordance with embodiments of the present disclosure. As described above, in various embodiments, an application provides the script authoring 405 interface to enable the user to define video effects and gestures corresponding to text segments of a script, and the presentation 412 interface to allow the user to present the script in a live video stream (e.g., the video 422), including the video effect. In one example, the application generates adaptive video effects which adjusts video effects in real-time (e.g., during presentation 412 in the live video stream) for maintaining connections between video effect, speech, and gesture as defined by the user, while handling the deviations that might happen during live presentations.

In various embodiments, adaptive animation P_{adp} (t, gₜ) is defined as a function of graphic parameters (e.g., parameters of graphical elements in the video effect) that are controlled both by the time of speech (t) and the gesture (gₜ) at a particular time interval. For example, the adaptive animation function P_{adp} (t, gₜ) blends between speech driven video effect and gesture driven video effect. In an embodiment, speech driven animation P_{speech}(t) 418 defines the animation of a graphical element 406 in the video 422 in response to speech during the presentation 412. In one example, the video effect is defined as an interpolation between the start state P_{S} and an end state P_{E} (e.g., the first frame of the animation defined by the user and the last frame of the animation) defined by the following equation:

$${P}_{s p e e c h} ( t ) = ρ ( t ) {P}_{S} + ( 1 - ρ ( t ) ) {P}_{E} . \qquad ( 1 )$$

In this example, the equation above causes the graphics to transform (e.g., perform that animation) without gestures. In an embodiment, the adaptive animation is performed during an adaptation interval 404. Furthermore, in some examples, the adaptive animation is evaluated periodically or aperiodically (e.g., every forty milliseconds) during the adaptation interval 404. Returning to the equation above, in an embodiment, P_{E} is the end state of the video effect the user designated during script authoring 405, and P_{S} is the start state which is detected and/or captured by the application based on the user's gesture (e.g., the time that the video effect is triggered). In the equation above, ρ(t) is a cubic function that eases the video effects between the start state and the end state.

In one example, the video effect is moved along to the end state gradually using the equation above. In addition, default video effects are used to transition between states and/or frames of the video effect defined by the user in an embodiment. In addition, in an embodiment, the cadence of the speaker is used to transition between states and/or frames of the video effect. Furthermore, in various embodiments, the gestures determine how the video effect moves to the end state, where P_{gesture}(t) is the video effect of the graphic element 406, given the current gesture performance. As mentioned in above, video effects (e.g., the graphical element 406) are mapped to gestures (e.g., a gesture 440) by recording a set of user created mappings between parameters of graphical elements in the video effect P_{record}⁽ⁱ⁾ and the gesture performed by the user g_{record}⁽ⁱ⁾ defined by the following equation:

$${A}_{record} = {\{ ( {P}_{record}^{( i )} , {g}_{record}^{( i )} ) \}}_{1 \leq i \leq n} . \qquad ( 2 )$$

In an embodiment, the A_{record} 402 is data that is stored by the application representing the mappings between parameters of graphical elements in the video effect P_{record}⁽ⁱ⁾ and the gesture performed by the user g_{record}⁽ⁱ⁾. Furthermore, in such embodiments, g_{record}⁽ⁱ⁾ represents a hand feature vector constructed using hand landmarks, and captures the position, scale, and rotation of a graphical element (e.g., relative to the center of the hand). For example, the hand feature vector can include the concatenation of a feature vector for each finger (e.g., thumb, index, middle, ring, and pinky) where each feature vector includes the scale, offset from the hand center, and the rotation angle of the finger. In an embodiment, during presentation 412, as a result of the limited number of discrete samples collected during script authoring 405 and the continuous space of gestures (e.g., the vector representing gestures), the video effect is computed by at least determining a weighted summation of all the recorded video effect-gesture mappings (e.g., the A_{record} 402) based on the similarity between a current gesture and all the recorded gestures:

$${P}_{g e sture} ( {g}_{t} ) = {\sum }_{i = 1}^{n} \frac{{s}^{( i )}}{{\sum }_{i = 1}^{n} {s}^{( i )}} {P}_{record}^{( i )} \qquad ( 3 )$$

$${s}^{( i )} = {e}^{- ( {∈}_{s} ( max ( 0 , ‖ {g}_{t} - {g}_{r e c o r d}^{( i )} ‖ - {b}_{s} ) ) )} \qquad ( 4 )$$

Where s⁽ⁱ⁾ represents the similarity score indicating how close the currently performed gestures (e.g., the pose of the user's hand in a particular frame of the video 422) is to the recorded gesture. Furthermore, in an embodiment, the value s⁽ⁱ⁾ is used to calculate a weight value w, defined below, to blend the recorded states of the graphical element 406 in the video effect to the current state of the graphical element 406 in the video 422 (e.g., the state of the animation being displayed in the video 422). In addition, in some embodiments, s⁽ⁱ⁾ can also be used to measure the intentionality of a particular gesture.

In various embodiments, regardless of the gestures performed during the presentation 405 (e.g., irrespective of the similarity scores s⁽ⁱ⁾ captured during the presentation 405), the application completes the video effect (e.g., transitions from start state P_{S} to the end state P_{E} during the adaptation interval 404). Returning to the equation above, ∈ₛ and bₛ represent hyper parameters, in various embodiments, that are determined empirically. In one example, the hyper parameters are determined based on detecting the intentional gestures with certain tolerance to the deviations caused by irrelevant factors (e.g., detection error, camera angle, etc.). In another example, the hyper parameters are determined based on weights to similar gestures to allow the mapping of discrete gesture states to continuous gesture state. In yet another example, the hyper parameters are determined based on filtering out unintentional gestures.

In various embodiments, the video effect is blended between speech and gestures using a function P_{adp}(t, gₜ) 420, which includes a weight value that dynamically changes based on the timing t, the gesture gₜ, and the discrepancy between gesture driven animation P_{gesture}(gₜ) and speech driven animation P_{speech} given by the following equations:

$${P}_{adp} ( t , {g}_{t} ) = w {P}_{g e sture} ( {g}_{t} ) + ( 1 - w ) {P}_{s p e e c h} ( t ) \qquad ( 5 )$$

$$w = F ( t , {g}_{t} , {r}_{t} ) \qquad ( 6 )$$

$${r}_{t} = ‖ {P}_{s p e e c h} ( t ) - {P}_{g e sture} ( {g}_{t} ) ‖ . \qquad ( 7 )$$

For example, in the equation (6) above, w represents the weight value, t is the current time (e.g., the time from equation (10) defined below, relative to the start of the adaptation interval 404 and the end of the adaptation interval 404). In addition, in the example above of equation (6), rₜ represents the difference in the point of time and/or speech the user is at (e.g., the word of the text segment the user is speaking) and the gesture performed by the user (e.g., the vector representation of the current gesture and/or pose at the time t), where P refers to the parameters of the graphical element 406 in the video effect. In various embodiments, the weight value w is further defined by the following equations:

$$w = F ( t , {g}_{t} , {r}_{t} ) = Γ ( t ) S ( {g}_{t} ) Φ ( {r}_{t} , t ) \qquad ( 8 )$$

$$Γ ( t ) = cos ( \frac{π}{2} t ) , \qquad ( 9 )$$

where S(gₜ) measures the intentionality of the gesture, and the closer the value is to zero, then the larger a penalty value is applied to the weight value, pushing the video effect towards the P_{speech} state. Furthermore, in some embodiments, the video effect is mapped or otherwise linked with a text segment which is used as a reference for a local timeline 414. For example, local timeline 414 is represented as the start and the end of the text segment (e.g., the portion of the script selected by the user to correspond to the video effect). In the example illustrated in FIG. 4, the sentence “Let's talk about ScriptLive, a tool,” includes the highlighted word “ScriptLive” (illustrated in FIG. 4 with a rectangle around it), which is selected by the user during script authoring 205. Continuing this example, the application determines an intendent time of the word “ScriptLive” determined based on an average amount of time the user takes to speak the word. In various embodiments, during the presentation 412, the location of the user within the script is tracking using a script index.

In various embodiments, the application determines, for the local timeline 414 representing an amount of time required by the user to speak the text segment, an active interval 416 where the adaptation of the video effect is performed. In one example, the active interval 416 extends the local timeline 414 by a value δ444. In one example, the value δ444 is set to two to account for gestures that precede lexical items in the text segment.

In an embodiment, during the active interval 416, the application monitors the gestures of the user and starts the adaptation interval 404 in response to a gesture performed by the user (e.g., as a result of the application determining the gesture was intentional based on a similarity score s⁽ⁱ⁾). In one example, a total duration of the adaptation interval 404 is determined based on the number of words in the text segment multiplied by a value for converting words into timing (e.g., the value of 400 millisecond per word is used to represent an amount of time the user will take to speak the text segment).

In various embodiments, during the adaptation interval 404, the adaptive animation P_{adp} (t, gₜ) (e.g., equation (5) defined above) is determined based on the time elapsed since the start of adaptation Δt and the estimated total time T given by the following equation:

$$t = min ( 1 , max ( 0 , \frac{Δ t}{T} ) ) \qquad ( 10 )$$

where t indicates a percentage (e.g., a value between zero and 1) of time remaining in the adaptation interval 404 when Δt is less than T and once the value Δt is greater than T the adaptation interval 404 has ended (e.g., is 100% complete). For example, time during adaptation interval 404 is an estimate of time calculated from zero to one hundred percent, which is incrementally increased during the presentation 412.

As described above in Equation (5), P_{adp}(t, gₜ) blends or otherwise selects between the speech driven animation P_{speech}(t) and gesture driven animation P_{gesture}(t) with a weight value w=F(t, gₜ, rₜ), in various embodiments. In one example, a larger weight value w causes the resulting video effect to be closer to the gesture driven video effect (e.g., increased interactivity between the presenter and the video effect), while smaller weight value w causes the resulting video effect to be closer to the speech driven video effect (e.g., video effect state set based on the timing associated with the text segment).

Returning to equations (8) and (9) above, in an embodiment, the weight value w is a function of time t, the gesture gₜ, and a discrepancy penalty rₜ (e.g., a change from the text segment and/or gesture associated with the video effect during script authoring 405). In one example, Γ(t) in equation (9) represents a timing factor which decreases from one to zero with the cosine function. In addition, in an embodiment, S(gₜ) represents an intentionality associated with particular gesture determined by evaluating the similarity (e.g., the similarity score s⁽ⁱ⁾) of the performed gesture to a recorded gesture. In such embodiments, the gesture intentionality is defined as the largest similarity value (e.g., the most similar gesture) by the following equation:

$$S ( {g}_{t} ) = max ( {\{ {s}^{i} \}}_{1 \leq i \leq n} ) . \qquad ( 11 )$$

In various embodiments, the application, when starting a video effect, determines gesture constancy, where a static gesture causes the application to display the video effect. For example, to determine gesture constancy, the application determines hand center movements within a time window (e.g., half a second) and, if the determined amount of movement is below a threshold, the application determines that the gesture is intentional regardless of the similarity score.

Returning to equation (8) above, in various embodiments, Φ(rₜ, t) causes the discrepancy penalty to be added the weight value when the P_{gesture} (gₜ) 408 deviates from the P_{speech}(t). In one example, the discrepancy penalty causes a faster convergence to the video effect state when the user deviates from the script and/or timing of the text segment. In various embodiments, Φ(rₜ, t) is defined by an inverse quadratic function defined by the following equation:

$$Φ ( {r}_{t} , t ) = \{ \begin{matrix}\frac{1}{1 + {∈}_{Φ} {r}_{t}^{2}} & if t \geq {t}_{0} \\ 1 & if t < {t}_{0}\end{matrix} , \qquad ( 12 )$$

where ∈_{Φ}=1 and t₀=0.8.

FIGS. 5A-5C illustrate a set of user interfaces 500A-500C of an application including an video effect associated with a gesture performed by a user during a presentation, in accordance with embodiments of the present disclosure. In various embodiments, the user interfaces 500A-500C is a continuation of a script authoring interface, as described above in connection with FIGS. 2 and/or 3. For example, the video effect that is displayed in the user interface 500A is mapped to the text segment “Farfalle” and the gesture performed by the user. In an embodiment, the user interface 500A displays video captured during the presentation and applies or otherwise displays the video effect.

In various embodiments, the video effect includes a plurality of states and/or frames mapped or otherwise tied to different words and/or text segments and gestures. For example, in the user interface 500B the video effect can include a first video effect state (e.g., a first position and scale of the ears displayed in FIG. 5B) associated with the word “Orecchiette” and a second video effect state associated with the words “little ears” (e.g., a second position and scale of the ears displayed in FIG. 5B). Furthermore, in various embodiments, multiple video effects can be displayed by the application in the video corresponding to multiple gestures performed by the user. In the example illustrated in FIG. 5C, the user performs two distinct gestures tied to two distinct video effects.

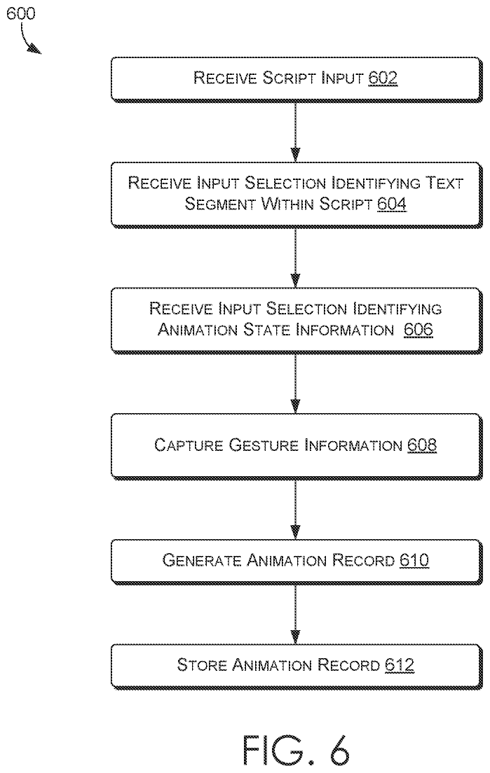

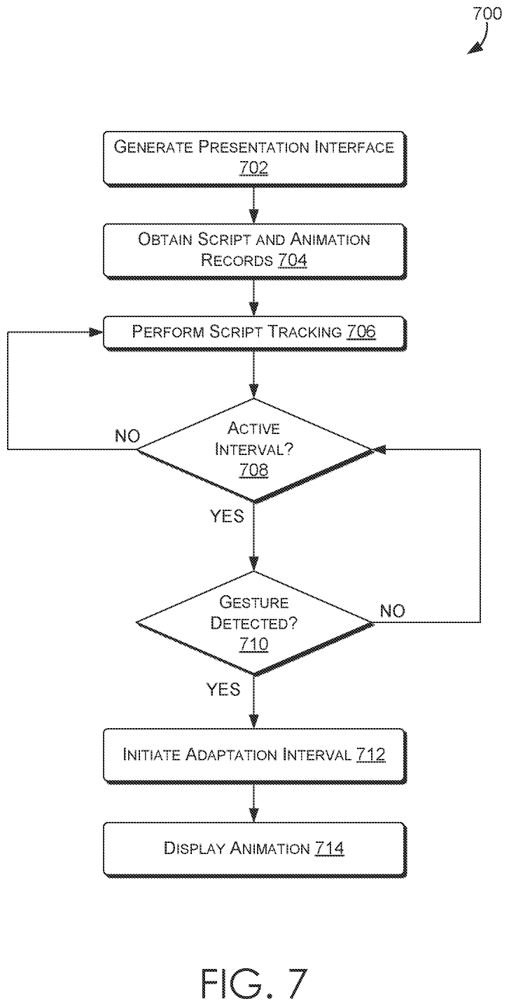

FIG. 6 is a flow diagram showing a method 600 for authoring a script, including triggers for video effect during presentations in accordance with at least one embodiment. Referring now to FIGS. 6 and 7, the methods 600 and 700 can be performed, for instance, by the video presentation tool 104 of FIG. 1. Each block of the methods 600 and 700 and any other methods described herein comprise a computing process performed using any combination of hardware, firmware, and/or software. For instance, various functions can be carried out by a processor executing instructions stored in memory. The methods 600 and 700 can also be embodied as computer-usable instructions stored on computer storage media. The methods 600 and 700 can be provided by a standalone application, a service or hosted service (standalone or in combination with another hosted service), or a plug-in to another product, to name a few.

Returning to FIG. 6, as shown at block 602, the system implementing the method 600 receives a script input. As described above in connection with FIG. 1, in various embodiments, a script authoring interface is provided to a user to enable the user to generate a script. For example, the user can provide an input to the script including words or other text.

At block 604, the system implementing the method 600 receives an input selection identifying a text segment within the script. For example, the user can highlight a text segment within the script using a mouse or other input device. At block 606, the system implementing the method 600 receives an input selection identifying video effect state information. In an example, the user selects a graphical element and provides parameters for displaying the graphical element in a video during presentation. For example, the user can select various objects using the script authoring interface 300, as described above in connection with FIG. 3, and place the objects in the video to define the parameters used to display the object during the video effect.

At block 608, the system implementing the method 600 captures gesture information. For example, the user performs a particular gesture relative to the graphical element in the video effect and causes the system implementing the method 600 to generate a feature vector representing the gesture. At block 610, the system implementing the method 600 generates an video effect record. As described above, in various embodiments, the video effect record is a mapping of the parameters of the graphical element and the feature vector representing the gesture performed by the user. At block 612, the system implementing the method 600 stores the video effect record. For example, the video effect record is stored in a remote data store that is accessible to the video presentation tool. In various embodiments, blocks 604-610 of the method 600 can be performed a plurality of times to generate frames of the video effects or otherwise animate the graphical element.

FIG. 7 is a flow diagram showing a method 700 for displaying video effects in a video during presentation of a script in accordance with at least one embodiment. At block 702, the system implementing the method 700 generates a presentation interface. For example, the presentation interface can be displayed in a user interface such as the user interfaces 500A-500C of FIGS. 5A-5C, as described above. In an embodiment, an application generates the presentation interface including a teleprompter to display the script and a video playback region to display video captured of the presentation.

At block 704, the system implementing the method 700 obtains the script and video effect records. For example, the user selects a previously saved script generated using the script authoring interface, and the application obtains the corresponding script and video effect records generated by the user. At block 706, the system implementing the method 700 performs script tracking. For example, the computing device executing the application includes a microphone to capture audio of the user during the presentation, generates a transcript based on the audio, and determines if the text in the transcript matches the script. As described above, a transcription service converts the audio stream to text, such as words spoken by the user. Furthermore, in various embodiments as described above, the transcript is generated continuously as the presentation interface is displayed.

At block 708, the system implementing the method 700 determines if an active interval has been initiated. For example, as described above in connection with FIG. 4, a number of words preceding the text segment triggers the active interval and causes the system implementing the method 700 to capture the user's gestures to determine if the gestures match the gesture information (e.g., the feature vector) stored in the video effect record. In an embodiment, if at block 708, the system implementing the method 700 determines the active interval has not been initiated, the method 700 returns to block 706 and continues to perform script tracking. However, if the system implementing the method 700 determines the active interval has been initiated, the method 700 continues to block 710.

At block 710, the system implementing the method 700 determines the gesture has been detected. In an embodiment, the video presentation tool matches a feature vector representing the user captured during the presentation (e.g., the user's current hand position) to the feature vector stored in the video effect record based on a similarity score. In various embodiments, the gesture constancy is used to determine that the gesture has been detected. Returning to FIG. 7, if gesture is detected, the system implementing the method 700 continues to block 712. However, if gesture is not detected (e.g., no match with the gestures stored in the video effect record), the system implementing the method 700 returns to block 708. At block 712, the system implementing the method 700 initiates the adaptation interval. For example, as described above in connection with FIG. 4, during the adaptation interval the system implementing the method 700 determines whether to advance the video effect based on speech and/or gestures captured during the presentation based on a weight value.

At block 714, the system implementing the method 700 displays the video effect. For example, the application displays a graphical element (e.g., text overlay) in the video captured of the presentation corresponding the gesture performed by the user. In various embodiments, the method 700 continues until presentation is ended (e.g., until the user ends the presentation by selecting a graphical user interface element within the presentation interface).

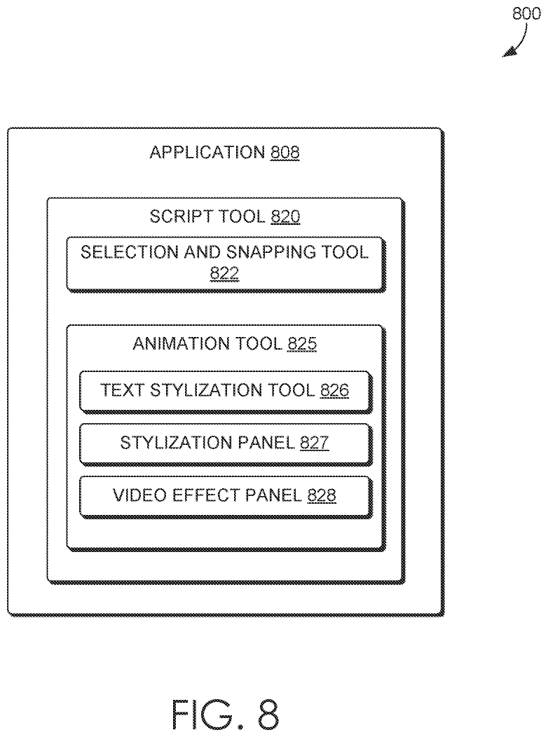

FIG. 8 is a block diagram of an example computing system for script authoring and presentation. In various embodiments, an application 808 provides one or more user interfaces with one or more interaction elements that allow a user to interact with a script and select video effects for display during presentation of the script. For example, the application 808 applies video effects to a video of a presentation of the script by a user. In an embodiment, the application 808 includes an animation tool 825, which allows the user to select parameters of a graphical element included in a video effect to be applied to the presentation when text segments are spoken and/or gestures are performed during the presentation. Furthermore, in various embodiments, the application 808 includes a script tool 820 that allows users to interact with the script. For example, the script tool 820 allows the user to select text segments and corresponding video effects.

In an embodiment, the script tool 820 includes a selection tool 822 and the animation tool 825. For example, the selection tool 822 accepts an input selecting sentences, text segments, or words from the script (e.g., by clicking or tapping and dragging across the transcript) and identifies a video. The selection tool 822, in an embodiment, provides the user with the ability to edit the selected text and/or apply video effects to the selected text using the animation tool 825.

The animation tool 825, in various embodiments, obtains a frame of the video effect and text segment selections taken from the script and applies the corresponding video effects during presentation. In one example, the animation tool 825 includes a text stylization tool 826, a stylization panel 827, and a video effect panel 828. In various embodiments, the text stylization tool 826 applies text stylizations or layouts on selected text segments of the script. For example, text stylizations or layouts include, but are not limited to, text stylization or layout (e.g., bold, italic, underline, text color, text background color, numeric list, bullet list, indent text, outdent text), font adjustments (e.g., font type or font size), and styles (e.g., headings or style type). Furthermore, in some embodiments, the text stylizations or layouts visually represent applied video effects. Interaction mechanisms provided by the animation tool 825, in some examples, also enable users to explore, discover, and/or modify parameters (e.g., duration, start point, end point, video effect type) of corresponding video effect through the interactions with the text segments with applied video effects in the script.

In some embodiments, the text stylization tool 826 applies text stylizations or layouts that represent multiple video effects of an effect type being applied on the text segment. As described above, during the script authoring process, for example, upon selection of the text segment, a determination is made as to the parameters of the graphical elements of an animation associated with the text segment. In an embodiment, additional video effects and/or video effects can also be applied to the same text segment and/or portions of the text segment. In these instances, additional visualizations can be applied to indicate that multiple video effects are being applied on a given text line. For example, these visualizations include different text stylizations or layouts for each video effect, respectively.

In some embodiments, the text stylization tool 826 includes a stylization mapping. The stylization mapping provides a mapping between text stylizations or layouts and the video effects. In some embodiments, a snapping tool 822 is provided to select and highlight individual words. For example, when highlighting, a user may use the snapping tool 822 to highlight an entire word automatically. In some other examples, snapping occurs to a portion of the word where the snapping tool automatically highlights sections, such as half of the word or a quarter of the word. In various embodiments, the animation tool 825 utilizes a stylization panel 827 to provide stylization option buttons in the script authoring interface. The stylization option buttons, when selected, apply parameters of the graphical elements of the video effect based on the particular stylization option button. In some embodiments, the stylization buttons include a visualization of the stylization type (e.g., bold, italic, and underline) and a corresponding visualization of the video effect (e.g., visual effect or audio effect) mapped to the particular stylization. For example, the stylization panel 827 includes a bold stylization button and, upon selection, applies bolding to a selected text segment while also applying a corresponding visual effect to a preview video. In this example, the stylization button includes a visualization of a bolding indicator (e.g., a bolded uppercase letter B) and a visualization indicating a particular visual effect (e.g., a camera, camera roll, magic wand, etc.).

In some embodiments, the stylization panel 827 includes configurable stylization buttons such that the selection of stylization buttons appearing on the stylization panel 827 are capable of being added, removed, changed, or rearranged to accommodate user preference. For example, the stylization panel 827 can include a customize mode, as described above in connection with FIG. 3.

In various embodiments, the video effect panel 828 provides visualizations of video effects associated with the video effect. For example, the video effects panel 828 provides video effect options that the user utilizes to adjust and edit a particular video effect. In an embodiment, a text pop-up visual effect includes additional video effect options such as images, objects, image effects, object effects, image visualization effects, object visualization effects, text effects, text visualization effects, color, font type, font size, location, and shadowing effect options. In some embodiments, upon selection of an option for an animation (e.g., a parameter), the video effects panel 828 provides visualizations of the animation and/or animation options associated with the selected option.

In some embodiments, the video effects panel 828 provides an “add effects” button for adding an additional video effect of the video effect type to a selected text segment. For example, a text stylization mapped to a visual effect type is applicable to a selected text segment and, upon selection of the “add effects” button, another visual effect is selected and adjusted via the video effects panel 828.

It is noted that FIG. 8 is intended to depict the representative components of an exemplary application 808. In some embodiments, however, individual components may have greater or lesser complexity than as represented in FIG. 8, components other than or in addition to those shown in FIG. 8 may be present, and the number, type, and configuration of such components may vary.

Having described embodiments of the present invention, FIG. 9 provides an example of a computing device in which embodiments of the present invention may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, RGB camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
obtaining a script and an animation associated with a text segment of the script and a gesture parameter;
determining a portion of an audio stream of a live video stream corresponds to the text segment;
determining a gesture performed by a user in the live video stream matches the gesture parameter; and
responsive to determining the gesture matches the gesture parameter, causing the animation to be displayed in the live video stream.

2. The method of claim 1, wherein the method further comprises:
obtaining a selection of words in the script from the user; and
generating the text segment based on the selection of words and at least one word in the script preceding the selection of words.

3. The method of claim 2, wherein determining the gesture performed by the user in the live video stream matches the gesture parameter further comprises, in response to detecting the at least one word in the portion of the audio stream, causing a gesture model generate gesture parameters corresponding to the gesture performed by the user.

4. The method of claim 1, wherein causing the animation to be displayed in the live video stream further comprises initiating an adaptation interval during which the animation is displayed based on at least one of: a second portion of the audio stream corresponding to a word in the text segment or a cadence of the user determined based on the second portion of the audio stream.

5. The method of claim 1, causing the animation to be displayed in the live video stream further comprises initiating an adaptation interval during which the animation is displayed based on a similarity score indicating an amount that a second gesture performed by the user in the live video stream matching a second gesture parameter.

6. The method of claim 5, wherein the animation includes a plurality of graphical states, where a graphical state of the plurality of graphical states defines a set of graphic parameters for an object in the animation.

7. The method of claim 6, method further comprises determining to advance the animation to a second graphical state of the plurality of graphical states based on a weight value is application to the similarity score.

8. A non-transitory computer-readable medium storing executable instructions embodied thereon, which, when executed by a processing device, cause the processing device to perform operations comprising:
obtaining a script and an animation to be applied to a video stream in response to a text segment included in the script and a gesture to be performed in the video stream, the animation including a plurality of states of an object; and
causing the animation to be displayed in the video stream in response to:
detecting a first portion of the text segment based on text converted from an audio stream corresponding to the video stream; and
detecting, by a gesture model, the gesture in the video stream.

9. The medium of claim 8, wherein the first portion of the text segment includes a plurality of words preceding a selecting of words in the script provided by a user through a script authoring interface.

10. The medium of claim 9, wherein the script authoring interface allows the user to associate the plurality of states of the object included in the animation with a plurality of gestures to be performed in the video stream.

11. The medium of claim 10, wherein causing the animation to be displayed in the video stream further comprises advancing the animation to a first state of the object of the plurality of states of the object based on detecting the gesture in the video stream.

12. The medium of claim 11, wherein causing the animation to be displayed in the video stream further comprises advancing the animation to a second state of the object of the plurality of states of the object based on a first amount of time elapsed from displaying the animation and a second amount need by the user to speak the text segment.

13. The medium of claim 11, wherein causing the animation to be displayed in the video stream further comprises advancing the animation to a second state of the object of the plurality of states of the object based on detecting a second gesture of the plurality of gestures in the video stream.

14. The medium of claim 8, wherein the plurality of states of the object are associated with a plurality of gestures.

15. The medium of claim 8, wherein detecting the gesture further comprises determining a similarity between a first vector generated based on a first image a user performing the gesture during script authoring and a second vector generated on a second image of the user during the video stream.

16. A system comprising:
a memory component; and
a processing device coupled to the memory component, the processing device to perform operations comprising:
obtaining a text segment include in a script and a gesture to be performed by a user during a video stream, the text segment and the gesture associated with an animation;
obtaining the video stream and an audio stream corresponding to the video stream;
detecting the gesture performed by the user in the video stream based on determining the user speaking a portion of the text segment included in the script; and
as a result of detecting the gesture, applying the animation to the video stream.

17. The system of claim 16, wherein the operations further comprise determining a location in the script based on a portion of the audio stream and a scrip index indicating locations within the script and corresponding words in the script.

18. The system of claim 17, wherein determining the user speaking the portion of the text segment included in the script further comprises determining the location in the script corresponds to the portion of the text segment.

19. The system of claim 16, where detecting the gesture performed by the user in the video stream further comprises determining an intentionality of an action performed by the user based on a hand of the user being static.

20. The system of claim 16, where detecting the gesture performed by the user in the video stream further comprises determining an intentionality of an action performed by the user based on a first vector generated based on a portion of the user captured during script authoring matching a second vector generated based on the portion of the user captured during presentation of the script.
